(19) United States
(12) Patent Application Publication
(10) Pub. No.: US 2021/0215245 A1
(43) Pub. Date: Jul. 15, 2021

(54) TWO-STAGE ACTUATING GEAR MECHANISM WITH ADJUSTABLE GEAR BACKLASH

(71) Applicant: Schaeffler Technologies AG & Co. KG, Herzogenaurach (DE)

(72) Inventors: Bastian Hain, Creglingen (DE); Christian Doerner, Sugenheim (DE)

(73) Assignee: Schaeffler Technologies AG & Co. KG, Herzogenaurach (DE)

(21) Appl. No.: 17/058,738

(22) PCT Filed: Apr. 23, 2019
(86) PCT No.: PCT/DE2019/100376

§ 371 Date: Nov. 25, 2020

(30) Foreign Application Priority Data
May 29, 2018 (DE) 10 2018 112 804.5

(51) Int. Cl. F16H 57/12; F16H 37/04; F16H 49/00; F16H 57/022; H02K 7/116

(52) U.S. Cl. CPC F16H 57/12; F16H 37/041; F16H 49/001; F16H 2057/125; H02K 7/116; F16H 2057/0222; F16H 57/022

(57) ABSTRACT

A two-stage actuating gear mechanism comprises a spur gear transmission as the first transmission stage and a harmonic drive as the second transmission stage. A spur gear transmission gear with inward facing teeth is designed simultaneously as a component of a harmonic generator of the harmonic drive. A gear with outward facing teeth that meshes with the gear with inward facing teeth is rigidly connected to a rotor of an electric motor, the motor housing of which is secured to the transmission housing of the harmonic drive. The motor housing is positioned relative to the transmission housing by means of a centering device which is eccentric to the rotational axis (A_{E}) of the rotor. An adjustable backlash between the gear with outward facing teeth and the gear with inward facing teeth is provided by a pivoting capability between the motor housing and the transmission housing.

### CROSS-REFERENCE TO RELATED APPLICATIONS

This application is the U.S. National Phase of PCT Application No. PCT/DE2019/100376 filed on Apr. 23, 2019 which claims priority to DE 10 2018 112 804.5 filed on May 29, 2018, the entire disclosures of which are incorporated by reference herein.

### TECHNICAL FIELD

This disclosure relates to a two-stage actuating gear mechanism and further to a method for assembling such an actuating gear mechanism.

### BACKGROUND

A generic actuating gear mechanism is known for example from DE 10 2015 201 807 A1. It is an actuating gear mechanism of a variable compression ratio mechanism. The first stage of the actuating gear mechanism is designed as a spur gear transmission, the second stage is designed as a harmonic drive. The known actuating gear mechanism is part of an actuator which adjusts a first eccentric shaft which adjusts a further eccentric shaft via a so-called control connection.

Further devices for adjusting the compression ratio of an internal combustion engine, namely a reciprocating piston engine, are known, for example, from documents U.S. Pat. No. 8,726,858 B2 and EP 2787 196 B1.

Adjusting the compression ratio is particularly advantageous for turbocharged gasoline engines. If the engine is operated with a low load, a high compression ratio can be set, with which a particularly high efficiency can be achieved. If, on the other hand, a particularly high torque of the engine is required, it can be operated with a higher load and lower compression.

### SUMMARY

The object of the disclosure is to provide a multi-stage actuating gear mechanism that is further developed compared to the prior art and suitable in particular for use in a device for adjusting the compression ratio of a reciprocating piston engine, which is characterized by a compact, easy-to-assemble structure.

The object is achieved by a two-stage actuating gear mechanism having the features described herein. The actuating gear mechanism can be assembled in the method also described herein. The configurations and advantages of the disclosure explained below in connection with the assembly method also apply analogously to the device, i.e., the two-stage actuating gear mechanism, and vice versa.

In a basic concept known per se, the actuating gear mechanism comprises a spur gear transmission as a first transmission stage and a harmonic drive as a second transmission stage. A spur gear transmission gear with inward facing teeth is designed simultaneously as a component of a harmonic generator of the harmonic drive. A gear with outward facing teeth that meshes with the gear with inward facing teeth and is smaller in comparison is rigidly connected to a rotor of an electric motor. The motor housing of the electric motor is secured to the transmission housing of the harmonic drive.

According to the disclosure, the motor housing is positioned relative to the transmission housing with the aid of a centering device eccentric to the rotational axis of the rotor of the electric motor, wherein an adjustable backlash between the gear with outward facing teeth and the gear with inward facing teeth is provided by a pivoting capability between the motor housing and the transmission housing.

According to a possible embodiment, the centering device comprises a centering pin, the central axis of which represents the pivot axis between the motor housing and the transmission housing. An elongated hole or a plurality of elongated holes can be formed in at least one of the housings, i.e., in the motor housing and/or the transmission housing, in order to ensure the limited pivoting capability between the motor housing and the transmission housing and the fixability in a variable angular position.

According to an alternative embodiment, the centering device is formed by a receptacle in the transmission housing. The motor housing of the electric motor is inserted into this receptacle in a manner that can be rotated about the pivot axis that enables backlash adjustment. The pivot axis is thus provided by the central axis of the receptacle.

The distance between the stated pivot axis and the rotational axis of the electric motor, i.e., the axis of the gear with outward facing teeth, can be less than the distance between the rotational axis of the electric motor and the central axis of the harmonic drive, i.e., the axis of symmetry of the gear with inward facing teeth, which also represents a component of the harmonic drive. For example, the distance between the pivot axis and the rotational axis of the electric motor is at least 6% and no more than 40% of the distance between the rotational axis of the gear with outward facing teeth that meshes with the gear with inward facing teeth and the central axis of the harmonic drive. All three stated axes, i.e., the pivot axis, the rotational axis of the electric motor and the central axis of the harmonic drive, can be within the cross section of the receptacle of the transmission housing.

The two-stage actuating gear mechanism, designed as a reduction gear, can be assembled as follows in each of the two embodiments:

A harmonic drive, which has a transmission housing with a first centering contour, is provided; an input-side component, in particular in the form of an inner ring of a harmonic generator, of the harmonic drive is designed as a gear with inward facing teeth,
furthermore, an electric motor is provided, the motor shaft of which is rigidly connected to a gear with outward facing teeth and protrudes from a motor housing, which has a second centering contour arranged eccentrically on the motor housing,
the transmission housing is assembled with the motor housing in such a way that a pivot axis is formed between the two housings by the centering contours,
a relative angular position between the transmission housing and the motor housing is adjusted such that a spur gear transmission with pre-defined backlash is formed by the gear with inward facing teeth and the gear with outward facing teeth, and
the transmission housing is fixed, in particular by screwing, relative to the motor housing in the set angular position.

To set the final angular position between the motor housing of the electric motor on the one hand and the transmission housing of the harmonic drive on the other hand, the motor housing can first be rotated relative to the transmission housing until it is stopped or blocked. The motor housing is then rotated back through a pre-defined angle, whereby a pre-defined backlash of the spur gear transmission formed from the gear with outward facing teeth and the gear with inward facing teeth is set.

In one embodiment, the internally toothed gear of the spur gear transmission is simultaneously designed as an inner ring of a rolling bearing of the harmonic generator. A non-circular rolling element raceway is formed by the inner ring. In contrast to the inner ring, the associated outer ring of the rolling bearing can be preformed and is provided for deforming a, for example, cup-shaped transmission element with outward facing teeth. The toothing of the flexible transmission element engages in an internal toothing, being fixed to the housing, of the harmonic drive.

The gear ratio of the entire two-stage actuating gear mechanism is, for example, 250:1. Because of this extreme gear ratio, in mechanical terms, only slightly loadable gear components are sufficient for the first transmission stage, i.e., the spur gear transmission, in typical applications. For example, the input torque of the spur gear transmission is 0.5 Nm and the output torque of the spur gear transmission is 1.25 Nm. To produce components that absorb these low loads, rational, known manufacturing processes such as forming and sintering can be considered.

The two-stage actuating gear mechanism is particularly suitable for use in a device for varying the compression ratio of a reciprocating piston engine. Such a device is also referred to for short as a VCR (Variable Compression Ratio) device. The actuating gear mechanism can also be used in industrial systems, for example in robots or machine tools.

### BRIEF DESCRIPTION OF THE DRAWINGS

Below, two exemplary embodiments of the disclosure are explained in more detail by means of a drawing. In the figures:

FIG. 1 shows a first exemplary embodiment of a two-stage actuating gear mechanism in a sectional view,

FIG. 2 shows a schematic front view of the features of the actuating gear mechanism according to FIG. 1, and

FIGS. 3 and 4 show an electric motor of a further two-stage actuating gear mechanism in front and rear views.

### DETAILED DESCRIPTION OF THE EMBODIMENTS

Unless otherwise stated, the following explanations relate to both exemplary embodiments. Parts or geometric details that correspond to each other or have basically the same effect are marked with the same reference symbols in all figures.

A two-stage actuating gear mechanism, identified overall by reference number 1, is used in a VCR device (not shown), i.e., a device for varying the compression ratio of a reciprocating piston engine. With regard to the principle function of the VCR device, reference is made to the prior art cited at the outset.

The actuating gear mechanism 1 comprises a spur gear transmission 2 as the first transmission stage and a harmonic drive 3 as the second transmission stage. Here, a gear 4 with inward facing teeth is a component of both transmission stages 2, 3.

The gear 4 with inward facing teeth meshes with a smaller gear 5 with outward facing teeth, which is rigidly connected to a motor shaft 6 and a rotor 7 of an electric motor 8. The associated stator of the electric motor is denoted by 9. The stator 9 is located in a motor housing 10 of the electric motor 8. In the exemplary embodiments, the electric motor 8 is designed as a brushless DC motor. A connector housing 30 is part of the electric motor 8.

The motor housing 10 is adjustable in both exemplary embodiments, as will be explained in more detail below, and connected to the transmission housing of the harmonic drive 3, which is denoted by 11.

The gear 4 with inward facing teeth is an input-side component of the harmonic drive 3. The toothing of the gear 4 is denoted by 33, the toothing of the smaller gear 5 with outward facing teeth is denoted by 32. The gear 4 with inward facing teeth is also designed as an inner ring 12 of a rolling bearing 13, namely a ball bearing. The pitch radius of the toothing 33 of the gear 4 is denoted by TR.

The rolling bearing 13 is part of a harmonic generator, denoted by 29, of the harmonic drive 3. The outer contour of the inner ring 12 is non-circular, namely elliptical, is shaped and forms a rolling bearing raceway 14 on which balls 15 roll as rolling elements. In contrast to the inner ring 12, the associated outer ring 16 of the rolling bearing 13 is flexible and permanently adapts to the non-circular shape of the inner ring 12.

The outer ring 16 is surrounded by a cup-shaped elastic transmission element 17 with outward facing teeth, which is referred to as a flexible cup. The external toothing of the transmission element 17, denoted by 18, engages partially, namely at two diametrically opposite points, in an internal toothing 19 which is formed by a toothing ring 20 arranged rigidly in the transmission housing 11. The number of teeth of the external toothing 18 deviates slightly, namely by two, from the number of teeth of the internal toothing 19. This has the effect that a full rotation of the inner ring 12 in relation to the transmission housing 11 is converted into a slight pivoting between the elastic transmission element 17 and the transmission housing 11.

The transmission housing 11 is rigidly connected to the engine block of the reciprocating piston engine (not shown). The elastic transmission element 17 is connected with the aid of a screw 21 to an eccentric shaft 22, which enables the compression ratio of the reciprocating piston engine to be adjusted in a manner known per se.

The central axis of the harmonic drive 3 is denoted by A_{W} and is identical to the central axis of the eccentric shaft 22. The rotational axis of the electric motor 8 denoted by A_{E} is parallel and spaced apart from the central axis A_{W}. When installing the actuating gear mechanism 1, the motor housing 10 is positioned relative to the transmission housing 11 in such a way that a defined backlash of the spur gear transmission 2 occurs. In particular, the spur gear transmission 2 can be adjusted without backlash. For this purpose, a centering device 23 is provided which comprises centering contours 24, 25 on the transmission side and on the electric motor side.

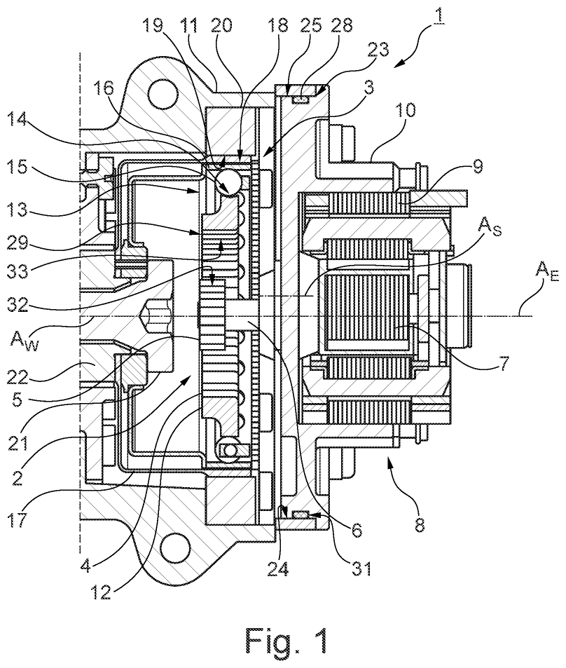

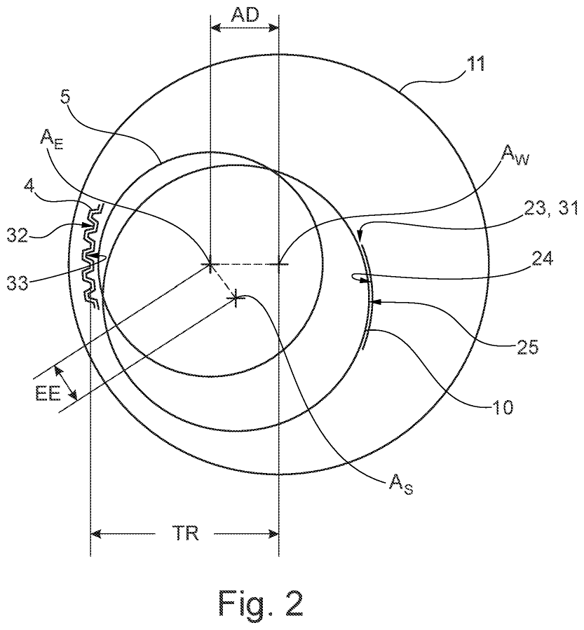

In the exemplary embodiment according to FIGS. 1 and 2, the motor housing 10 of the electric motor 8 is inserted into a receptacle 31 in the transmission housing 11. The gear-side centering contour 24 is thus formed directly by the circular receptacle 31. On sides of the electric motor, the motor housing 10, which likewise has a circular cross section in this area, forms the associated centering contour 25. A pivot axis A_{S} is given by the axis of symmetry of the receptacle 31 and thus the centering device 23. The effect of a seal denoted by 28 between the housings 10, 11 is practically not dependent on the angular position of the motor housing 10 relative to the transmission housing 11.

The distance between the pivot axis A_{S}, about which the motor housing 10 can be rotated within the receptacle 31, and the rotational axis A_{E} of the electric motor 8 is denoted by EE and is less than the distance denoted by AD between the rotational axis A_{E} and the central axis A_{W} of the harmonic drive 3. All axes A_{S}, A_{E}, A_{W} lie, as can be seen from FIG. 2, within the circular cross section of the receptacle 31.

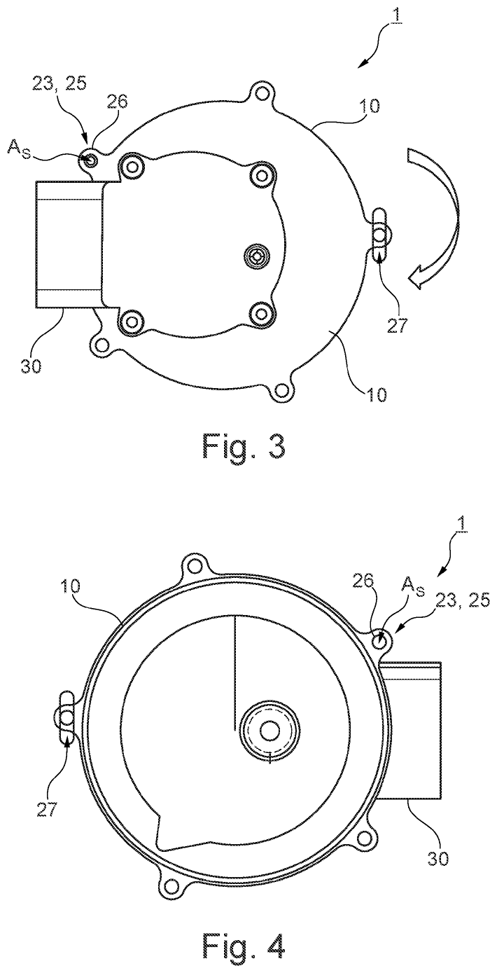

In the exemplary embodiment according to FIGS. 3 and 4, the centering device 23 has a centering pin 26 which is inserted into the centering contours 24, 25 and couples the motor housing 10 to the transmission housing 11 in such a way that the pivot axis A_{S} is formed between the transmission housing 11 and the motor housing 10, which in this case is defined by the central axis of the centering pin 26.

When mounting the actuating gear mechanism 1 according to FIGS. 3 and 4, the motor housing 10 is first secured to the transmission housing 11 and the centering pin 26 is inserted. In this state, there remains at least a slight pivoting capability between the two housings 10, 11 of the actuating gear mechanism 1.

The centering pin 26 is arranged eccentrically with respect to the rotational axis A_{E}. The centering pin 26 is also spaced apart from the central axis A_{W} of the harmonic drive 3. When the motor housing 10 is secured to the transmission housing 11, the spur gear transmission 2 is in principle already functional.

In this state, the motor housing 10 is rotated about the centering pin 26 until the backlash of the spur gear transmission 2 is removed, i.e., the spur gear transmission 2 is set to block. The motor housing 10 is then turned back by a certain pre-defined angle in order to set a pre-defined backlash of the spur gear transmission 2. In this setting, the motor housing 10 is finally fixed relative to the transmission housing 11. In order to enable fixation in variable positioning, elongated holes 27 are located on the transmission housing 11. Thus, a readjustment of the backlash of the spur gear transmission 2 is possible. In an analogous manner, elongated holes 27 could be located on the motor housing 10 instead of on the transmission housing 11.

The backlash adjustment of the spur gear transmission formed from the gears 4, 5 is carried out in a corresponding manner in the case of the actuating gear mechanism 1: The motor housing 10 is pivoted as far as possible within the receptacle 31, i.e., up to the stop. Then a pre-defined backlash is set by pivoting the motor housing 10 back about the pivot axis A_{S}.

### LIST OF REFERENCE SYMBOLS

1 Actuating gear mechanism

2 Spur gear transmission

3 Harmonic drive

4 Gear with inward facing teeth

5 Gear with outward facing teeth

6 Motor shaft

7 Rotor

8 Electric motor

9 Stator

10 Motor housing

11 Transmission housing

12 Inner ring

13 Rolling bearing

14 Rolling bearing raceway

15 Ball

16 Outer ring

17 Elastic transmission element, Flextopf

18 External toothing

19 Internal toothing

20 Gear ring

21 Screw

22 Eccentric shaft

23 Centering device

24 Centering contour

25 Centering contour

26 Centering pin

27 Elongated hole

28 Seal

29 Harmonic generator

30 Connector housing

31 Receptacle

32 Toothing of the gear 5

33 Toothing of the gear 4

AD Distance between the axes A_{W} and A_{S}

A_{W} Central axis of the harmonic drive

A_{E} Rotational axis of the electric motor

A_{S} Pivot axis

EE Distance between the axes A_{S} and A_{E}

TR Pitch radius of the gear 4

1. A two-stage actuating gear mechanism comprising:
a spur gear transmission as a first transmission stage,
a harmonic drive as a second transmission stage,
a first gear having inward facing teeth is configured as a component of both the spur gear transmission and the harmonic drive,
a second gear having outward facing teeth is configured to mesh with the first gear, the second gear rigidly connected to a rotor of an electric motor, and
a motor housing of the electric motor secured to a transmission housing of the harmonic drive, and
the motor housing positioned relative to the transmission housing by a centering device eccentric to a rotational axis of the rotor, and the motor housing configured to pivot relative to the transmission housing about a pivot axis to adjust a backlash between the second gear and the first gear.

2. The two-stage actuating gear mechanism of claim 1, wherein the centering device comprises a centering pin and the pivot axis is defined by a central axis of the centering pin.

3. The two-stage actuating gear mechanism of claim 2, wherein an elongated hole is formed in one of the motor housing or the transmission housing, the elongated hole configured to secure the motor housing to the transmission housing in variable positions.

4. The two-stage actuating gear mechanism of claim 1, wherein the centering device is formed by a receptacle in the transmission housing, the motor housing disposed within the transmission housing.

5. The two-stage actuating gear mechanism of claim 4, wherein a first distance between the pivot axis and the rotational axis of the electric motor is less than a second distance between the rotational axis of the electric motor and a central axis of the harmonic drive.

6. The two-stage actuating gear mechanism of claim 1, wherein the first gear is configured as an inner ring of a rolling bearing of the harmonic drive.

7. The two-stage actuating gear mechanism of claim 6, wherein the rolling bearing further comprises an outer ring, the outer ring configured for deforming a cup-shaped harmonic drive transmission element with outward facing teeth.

8. A method of assembling a two-stage actuating gear mechanism, comprising:
providing a harmonic drive including a transmission housing having a first centering contour, and an input-side component of the harmonic drive is configured as a first gear with inward facing teeth,
providing an electric motor including a motor shaft rigidly connected to a second gear with outward facing teeth the motor shaft protruding from a motor housing, the motor housing having a second centering contour arranged eccentrically on the motor housing,
assembling the transmission housing and the motor housing such that the first and second centering contours form a pivot axis between the transmission housing and the motor housing,
setting of an angular position between the transmission housing and the motor housing such that a spur gear transmission with pre-defined backlash is formed by the first gear and the second gear, and
fixing of the transmission housing relative to the motor housing at the angular position.

9. The method of claim 8, wherein, in the setting of the angular position, the motor housing is first rotated relative to the transmission housing to a zero backlash position, and then rotated back by a pre-defined angle.

10. The two-stage actuating gear mechanism of claim 1, wherein the two-stage actuating gear mechanism is used as a device for varying a compression ration of a reciprocating piston engine.

11. The two-stage actuating gear mechanism of claim 1, wherein the first gear is configured as an input-side component of the harmonic drive.

12. The two-stage actuating gear mechanism of claim 6, wherein the inner ring is non-circular.

13. The two-stage actuating gear mechanism of claim 7, wherein the outer ring is flexible.

14. The two-stage actuating gear mechanism of claim 1, wherein the rotational axis of the electric motor is offset from a central axis of the harmonic drive.

15. The two-stage actuating gear mechanism of claim 14, wherein the pivot axis is: i) parallel to and offset from the rotational axis of the electric motor, and ii) parallel to and offset from the central axis of the harmonic drive.

16. A two-stage actuating gear mechanism, comprising:
a spur gear transmission,
a harmonic drive having a transmission housing,
a first gear configured as a component of both the spur gear transmission and the harmonic drive,
a second gear configured to mesh with the first gear, the second gear rigidly connected to a rotor of an electric motor, and
a motor housing of the electric motor positioned relative to the transmission housing by a centering device eccentric to a rotational axis of the rotor, the motor housing configured to pivot relative to the transmission housing about a pivot axis to adjust a backlash between the second gear and the first gear.

17. The two-stage actuating gear mechanism of claim 16, wherein the centering device is formed by a receptacle arranged within the transmission housing.

18. The two-stage actuating gear mechanism of claim 16, wherein the centering device comprises a centering pin, and the pivot axis is defined by a central axis of the centering pin.

19. The two-stage actuating gear mechanism of claim 16, wherein the pivot axis is: i) offset a first distance from the rotational axis of the electric motor, and ii) offset a second distance from a central axis of the harmonic drive.

20. The two-stage actuating gear mechanism of claim 19, wherein the first distance is less than the second distance.
